(19) United States
(12) Patent Application Publication
(10) Pub. No.: US 2023/0005283 A1
(43) Pub. Date: Jan. 5, 2023

(54) INFORMATION EXTRACTION METHOD AND APPARATUS, ELECTRONIC DEVICE AND READABLE STORAGE MEDIUM

(71) Applicant: BEIJING BAIDU NETCOM SCIENCE TECHNOLOGY CO., LTD., Beijing (CN)

(72) Inventors: Han LIU, Beijing (CN); Teng HU, Beijing (CN); Yongfeng CHEN, Beijing (CN)

(73) Assignee: BEIJING BAIDU NETCOM SCIENCE TECHNOLOGY CO., LTD., Beijing (CN)

(21) Appl. No.: 17/577,531

(22) Filed: Jan. 18, 2022

(30) Foreign Application Priority Data
Jun. 30, 2021 (CN) 202110733719.6

(51) Int. Cl. G06V 30/18; G06V 30/19; G06V 30/262; G06F 40/20

(52) U.S. Cl. CPC G06V 30/18; G06V 30/19093; G06V 30/274; G06F 40/20

(57) ABSTRACT

The present disclosure provides an information extraction method and apparatus, an electronic device and a readable storage medium, and relates to the field of natural language processing technologies. The information extraction method includes: acquiring a to-be-extracted text; acquiring a sample set, the sample set including a plurality of sample texts and labels of sample characters in the plurality of sample texts; determining a prediction label of each character in the to-be-extracted text according to a semantic feature vector of each character in the to-be-extracted text and a semantic feature vector of each sample character in the sample set; and extracting, according to the prediction label of each character, a character meeting a preset requirement from the to-be-extracted text as an extraction result of the to-be-extracted text. The present disclosure can simplify steps of information extraction, reduce costs of information extraction and improve flexibility and accuracy of information extraction.

### CROSS-REFERENCE TO RELATED APPLICATIONS

The present application claims the priority of Chinese Patent Application No. 202110733719.6, filed on Jun. 30, 2021, with the title of “INFORMATION EXTRACTION METHOD AND APPARATUS, ELECTRONIC DEVICE AND READABLE STORAGE MEDIUM.” The disclosure of the above application is incorporated herein by reference in its entirety.

### TECHNICAL FIELD

The present disclosure relates to the field of computer technologies, and in particular, to the field of natural language processing technologies. An information extraction method and apparatus, an electronic device and a readable storage medium are provided.

### BACKGROUND

In daily document processing, it is common to extract information. For example, in contract processing, there is a need to know “Party A”, “Party B”, “contract amount” and other information in a document. In legal judgment processing, there is a need to know information such as “defendant”, “prosecutor” and “suspected crime” in a document.

In the prior art, information is generally extracted by an information extraction model, but the information extraction model is effective only for corpus related to a training field, but cannot be accurately extract corpus outside the training field due to the lack of corresponding training data. In order to improve extraction capabilities of the information extraction model in different fields, the most intuitive way is to acquire a large amount of annotation data for training. However, the large amount of annotation data requires a lot of labor costs and is difficult to acquire.

### SUMMARY

According to a first aspect of the present disclosure, an information extraction method is provided, including: acquiring a to-be-extracted text; acquiring a sample set, the sample set including a plurality of sample texts and labels of sample characters in the plurality of sample texts; determining a prediction label of each character in the to-be-extracted text according to a semantic feature vector of each character in the to-be-extracted text and a semantic feature vector of each sample character in the sample set; and extracting, according to the prediction label of each character, a character meeting a preset requirement from the to-be-extracted text as an extraction result of the to-be-extracted text.

According to a second aspect of the present disclosure, there is provided an electronic device, including: at least one processor; and a memory communicatively connected with the at least one processor; wherein the memory stores instructions executable by the at least one processor, and the instructions are executed by the at least one processor to enable the at least one processor to perform an information extraction method, wherein the information extraction method includes: acquiring a to-be-extracted text; acquiring a sample set, the sample set including a plurality of sample texts and labels of sample characters in the plurality of sample texts; determining a prediction label of each character in the to-be-extracted text according to a semantic feature vector of each character in the to-be-extracted text and a semantic feature vector of each sample character in the sample set; and extracting, according to the prediction label of each character, a character meeting a preset requirement from the to-be-extracted text as an extraction result of the to-be-extracted text.

According to a third aspect of the present disclosure, there is provided a non-transitory computer readable storage medium with computer instructions stored thereon, wherein the computer instructions are used for causing a computer to perform an information extraction method, wherein the information extraction method includes: acquiring a to-be-extracted text; acquiring a sample set, the sample set comprising a plurality of sample texts and labels of sample characters in the plurality of sample texts; determining a prediction label of each character in the to-be-extracted text according to a semantic feature vector of each character in the to-be-extracted text and a semantic feature vector of each sample character in the sample set; and extracting, according to the prediction label of each character, a character meeting a preset requirement from the to-be-extracted text as an extraction result of the to-be-extracted text.

As can be seen from the above technical solutions, a prediction label of each character in a to-be-extracted text is determined through an acquired sample set, and then the character meeting a preset requirement is extracted from the to-be-extracted text as an extraction result of the to-be-extracted text, which does not require training of an information extraction model, simplifies steps of information extraction, reduces costs of information extraction, may not limit the field of the to-be-extracted text, and can extract information corresponding to any field name from the to-be-extracted text, thereby greatly improving flexibility and accuracy of information extraction.

It should be understood that the content described in this part is neither intended to identify key or significant features of the embodiments of the present disclosure, nor intended to limit the scope of the present disclosure. Other features of the present disclosure will be made easier to understand through the following description.

### BRIEF DESCRIPTION OF THE DRAWINGS

The accompanying drawings are intended to provide a better understanding of the solutions and do not constitute a limitation on the present disclosure. In the drawings,

FIG. 1 is a schematic diagram of a first embodiment according to the present disclosure;

FIG. 2 is a schematic diagram of a second embodiment according to the present disclosure;

FIG. 3 is a schematic diagram of a third embodiment according to the present disclosure; and

FIG. 4 is a block diagram of an electronic device configured to perform an information extraction method according to embodiments of the present disclosure.

### DETAILED DESCRIPTION

Exemplary embodiments of the present disclosure are illustrated below with reference to the accompanying drawings, which include various details of the present disclosure to facilitate understanding and should be considered only as exemplary. Therefore, those of ordinary skill in the art should be aware that various changes and modifications can be made to the embodiments described herein without departing from the scope and spirit of the present disclosure. Similarly, for clarity and simplicity, descriptions of well-known functions and structures are omitted in the following description.

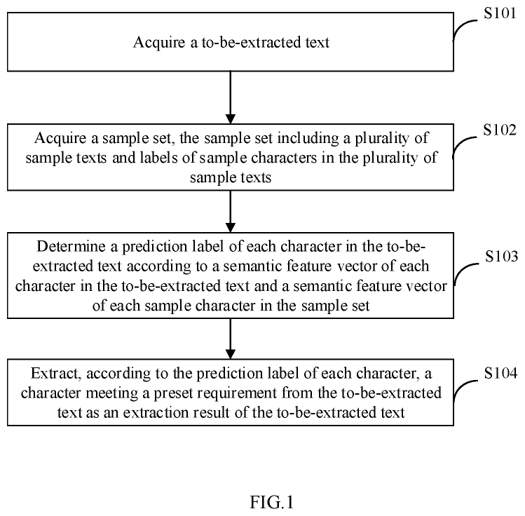

FIG. 1 is a schematic diagram of a first embodiment according to the present disclosure. As shown in FIG. 1, an information extraction method according to this embodiment may specifically include the following steps.

In S101, a to-be-extracted text is acquired.

In S102, a sample set is acquired, the sample set including a plurality of sample texts and labels of sample characters in the plurality of sample texts.

In S103, a prediction label of each character in the to-be-extracted text is determined according to a semantic feature vector of each character in the to-be-extracted text and a semantic feature vector of each sample character in the sample set.

In S104, a character meeting a preset requirement is extracted, according to the prediction label of each character, from the to-be-extracted text as an extraction result of the to-be-extracted text.

In the information extraction method according to this embodiment, a prediction label of each character in a to-be-extracted text is determined through an acquired sample set, and then the character meeting a preset requirement is extracted from the to-be-extracted text as an extraction result of the to-be-extracted text, which does not require training of an information extraction model, simplifies steps of information extraction, reduces costs of information extraction, may not limit the field of the to-be-extracted text, and can extract information corresponding to any field name from the to-be-extracted text, thereby greatly improving flexibility and accuracy of information extraction.

In this embodiment, the to-be-extracted text acquired by performing S101 consists of a plurality of characters. The field of the to-be-extracted text may be any field.

In this embodiment, after S101 is performed to acquire the to-be-extracted text, a to-be-extracted field name may be further acquired. The to-be-extracted field name includes a text of at least one character. The extraction result extracted from the to-be-extracted text is a field value in the to-be-extracted text corresponding to the to-be-extracted field name.

For example, if the to-be-extracted text is “Party A Zhang San” and the to-be-extracted field name is “Party A”, in this embodiment, a field value “Zhang San” corresponding to “Party A” is required to be extracted from the to-be-extracted text.

In this embodiment, after S101 is performed to acquire the to-be-extracted text, S102 is performed to acquire a sample set, the sample set including a plurality of sample texts and labels of sample characters in the plurality of sample texts.

In this embodiment, when S102 is performed to acquire the sample set, a pre-constructed sample set or a real-time constructed sample set may be acquired. Preferably, in order to improve efficiency of information extraction, in this embodiment, the sample set acquired by performing S102 is a pre-constructed sample set.

It may be understood that the sample set acquired by performing S102 includes a small number of sample texts, for example, a plurality of sample texts within a preset number. The preset number may be a small value. For example, in this embodiment, the sample set acquired includes only 5 sample texts.

In this embodiment, in the sample set acquired by performing S102, labels of different sample characters correspond to to-be-extracted field names A label of a sample character is configured to indicate whether the sample character is the beginning of a field value, the middle of a field value, or a non-field value.

In this embodiment, in the sample set acquired by performing S102, the label of each sample character may be one of B, I and O. The sample character with the label B indicates that the sample character is the beginning of a field value, the sample character with the label I indicates that the sample character is the middle of a field value, and the sample character with the label O indicates that the sample character is a non-field value.

For example, if a sample text included in the sample set in this embodiment is “Party A: Li Si” and the to-be-extracted field name in this embodiment is “Party A”, labels of the sample character in the sample text may be “O, O, O, B, I” respectively.

In this embodiment, after S102 is performed to acquire the sample set, S103 is performed to determine a prediction label of each character in the to-be-extracted text according to a semantic feature vector of each character in the to-be-extracted text and a semantic feature vector of each sample character in the sample set.

Specifically, in this embodiment, when S103 is performed to determine a prediction label of each character in the to-be-extracted text according to a semantic feature vector of each character in the to-be-extracted text and a semantic feature vector of each sample character in the sample set, the following optional implementation manner may be adopted: calculating, for each character in the to-be-extracted text, a similarity between the character and each sample character in the sample set according to the semantic feature vector of the character and the semantic feature vector of each sample character in the sample set; and taking the label of the sample character with the highest similarity to the character as the prediction label of the character.

That is, in this embodiment, similarities between characters in the to-be-extracted text and sample characters in the sample set are calculated according to semantic feature vectors, so as to take the label of the sample character with the highest similarity to the character in the to-be-extracted text as the prediction label of the character in the to-be-extracted text, thereby improving the accuracy of the determined prediction label.

Optionally, in this embodiment, when S103 is performed to calculate similarities between characters and sample characters, the following calculation formula may be used:

$$s i {m}_{j}^{i} = \frac{{S}_{i}^{T} \times {V}_{j}}{\sqrt{{S}_{i}^{T} \times {S}_{i}} \times \sqrt{{V}_{j}^{T} \times {V}_{j}}}$$

In the formula, simⱼⁱ denotes a similarity between an i^{th} character and a j^{th} sample character; Sᵢ denotes the semantic feature vector of the i^{th} character; T denotes transposition; and Vⱼ denotes the semantic feature vector of the j^{th} sample character.

In this embodiment, when S103 is performed, the semantic feature vector of each character in the to-be-extracted text or the semantic feature vector of each sample character in the sample text may be generated directly according to the to-be-extracted text or the sample text.

In order to improve accuracy of the generated semantic feature vector of each character in the to-be-extracted text, in this embodiment, when S103 is performed to generate the semantic feature vector of each character in the to-be-extracted text, the following optional implementation manner may be adopted: acquiring a to-be-extracted field name; splicing the to-be-extracted text with the to-be-extracted field name to obtain token embedding, segment embedding and position embedding of each character in a splicing result, for example, inputting the splicing result to an ERNIE model to obtain three vectors outputted by the ERNIE model for each character; and generating the semantic feature vector of each character in the to-be-extracted text according to the token embedding, the segment embedding and the position embedding of each character, for example, adding the token embedding, the segment embedding and the position embedding of each character, inputting such vectors to the ERNIE model, and taking an output result of the ERNIE model as the semantic feature vector of each character.

In order to improve accuracy of the generated semantic feature vector of each sample character in the sample text, in this embodiment, when S103 is performed to generate the semantic feature vector of each sample character in the sample set, the following optional implementation manner may be adopted: acquiring a to-be-extracted field name; splicing, for each sample text in the sample set, the sample text with the to-be-extracted field name to obtain token embedding, segment embedding and position embedding of each sample character in a splicing result; and generating the semantic feature vector of each sample character in the sample text according to the token embedding, the segment embedding and the position embedding of each sample character. In this embodiment, the method for obtaining the three vectors and the semantic feature vector of each sample character in the sample text is similar to the method for obtaining the three vectors and the semantic feature vector of each character in the to-be-extracted text.

In this embodiment, when S103 is performed to splice the to-be-extracted text with the to-be-extracted field name or splice the sample text with the to-be-extracted field name, splicing may be performed according to a preset splicing rule. Preferably, the splicing rule in this embodiment is “[CLS] to-be-extracted field name [SEP] to-be-extracted text or sample text [SEP]”, wherein [CLS] and [SEP] are special characters.

For example, if the to-be-extracted field name in this embodiment is “Party A”, the sample text is “Party A: Li Si” and the to-be-extracted text is “Party A: Zhang San”, a splicing result acquired may be “[CLS] Party A [SEP] Party A: Li Si [SEP]” and “[CLS] Party A [SEP] Party A: Zhang San[SEP]”.

In this embodiment, after S103 is performed to determine the prediction label of each character in the to-be-extracted text, S104 is performed to extract, according to the prediction label of each character, a character meeting a preset requirement from the to-be-extracted text as an extraction result of the to-be-extracted text. The preset requirement in this embodiment may be one of a preset label requirement and a preset label sequence requirement and correspond to the to-be-extracted field name.

In this embodiment, when S104 is performed to extract, according to the prediction label of each character, a character meeting a preset requirement from the to-be-extracted text as an extraction result of the to-be-extracted text, characters in the to-be-extracted text that meet a preset label requirement may be sequentially determined in a character order, and then the determined characters are extracted to form the extraction result.

In this embodiment, when S104 is performed to extract, according to the prediction label of each character, a character meeting a preset requirement from the to-be-extracted text as an extraction result of the to-be-extracted text, the following optional implementation manner may be adopted: generating a prediction label sequence of the to-be-extracted text according to the prediction label of each character; determining a label sequence in the prediction label sequence meeting a preset label sequence requirement; and extracting, from the to-be-extracted text, a plurality of characters corresponding to the determined label sequence as the extraction result.

For example, if the to-be-extracted field name in this embodiment is “Party A”, the to-be-extracted text is “Party A Zhang San”, a generated prediction label sequence is “OOOBI” and a label sequence requirement corresponding to the to-be-extracted field name “Party A” is “BI”, “Zhang San” corresponding to the determined label sequence “BI” is extracted from the to-be-extracted text as an extraction result.

That is, in this embodiment, in the manner of generating a prediction label sequence, a field value in the to-be-extracted text corresponding to the to-be-extracted field name can be quickly determined, and then the determined field value is extracted as an extraction result, thereby further improving the efficiency of information extraction.

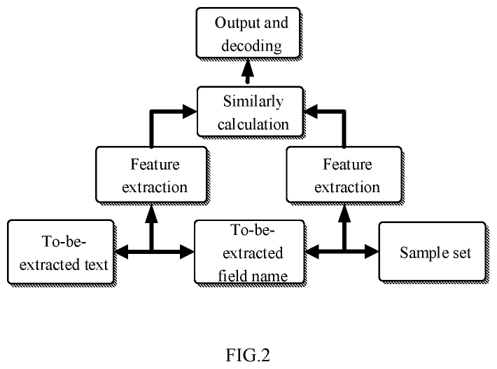

FIG. 2 is a schematic diagram of a second embodiment according to the present disclosure. As shown in FIG. 2, a flowchart of information extraction is shown in this embodiment. After a to-be-extracted text, a to-be-extracted field name and a sample set are acquired, feature extraction is performed according to the to-be-extracted field name to obtain a semantic feature vector of each character in the to-be-extracted text and a semantic feature vector of each sample character in the sample set respectively. Similarities are calculated according to the obtained semantic feature vectors, so as to determine a prediction label of each character in the to-be-extracted text. Output and decoding are performed according to the prediction label of each character, and then a decoding result is taken as an extraction result of the to-be-extracted text.

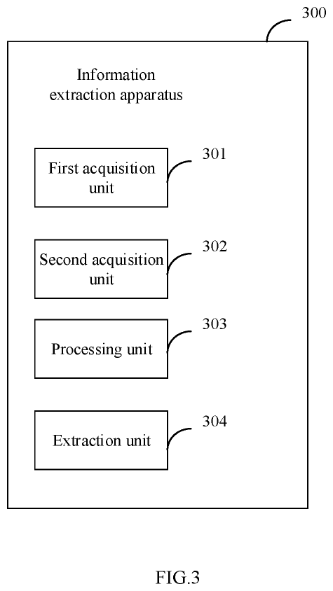

FIG. 3 is a schematic diagram of a third embodiment according to the present disclosure. As shown in FIG. 3, an information extraction apparatus 300 according to this embodiment may include: a first acquisition unit 301 configured to acquire a to-be-extracted text; a second acquisition unit 302 configured to acquire a sample set, the sample set including a plurality of sample texts and labels of sample characters in the plurality of sample texts; a processing unit 303 configured to determine a prediction label of each character in the to-be-extracted text according to a semantic feature vector of each character in the to-be-extracted text and a semantic feature vector of each sample character in the sample set; and an extraction unit 304 configured to extract, according to the prediction label of each character, a character meeting a preset requirement from the to-be-extracted text as an extraction result of the to-be-extracted text.

The to-be-extracted text acquired by the first acquisition unit 301 consists of a plurality of characters. The field of the to-be-extracted text may be any field.

After acquiring the to-be-extracted text, the first acquisition unit 301 may further acquire a to-be-extracted field name The to-be-extracted field name includes a text of at least one character. The extraction result extracted from the to-be-extracted text is a field value in the to-be-extracted text corresponding to the to-be-extracted field name.

In this embodiment, after the first acquisition unit 301 acquires the to-be-extracted text, the second acquisition unit 302 acquires a sample set, the sample set including a plurality of sample texts and labels of sample characters in the plurality of sample texts.

When acquiring the sample set, the second acquisition unit 302 may acquire a pre-constructed sample set or a real-time constructed sample set. Preferably, in order to improve efficiency of information extraction, in this embodiment, the sample set acquired by the second acquisition unit 302 is a pre-constructed sample set.

The sample set acquired by the second acquisition unit 302 includes a small number of sample texts, for example, a plurality of sample texts within a preset number. The preset number may be a small value. For example, the sample set acquired by the second acquisition unit 302 includes only 5 sample texts.

In the sample set acquired by the second acquisition unit 302, labels of different sample characters correspond to to-be-extracted field names. A label of a sample character is configured to indicate whether the sample character is the beginning of a field value, the middle of a field value, or a non-field value.

In the sample set acquired by the second acquisition unit 302, the label of each sample character may be one of B, I and O. The sample character with the label B indicates that the sample character is the beginning of a field value, the sample character with the label I indicates that the sample character is the middle of a field value, and the sample character with the label O indicates that the sample character is a non-field value.

In this embodiment, after the second acquisition unit 302 acquires the sample set, the processing unit 303 determines a prediction label of each character in the to-be-extracted text according to a semantic feature vector of each character in the to-be-extracted text and a semantic feature vector of each sample character in the sample set.

Specifically, when the processing unit 303 determines a prediction label of each character in the to-be-extracted text according to a semantic feature vector of each character in the to-be-extracted text and a semantic feature vector of each sample character in the sample set, the following optional implementation manner may be adopted: calculating, for each character in the to-be-extracted text, a similarity between the character and each sample character in the sample set according to the semantic feature vector of the character and the semantic feature vector of each sample character in the sample set; and taking the label of the sample character with the highest similarity to the character as the prediction label of the character.

That is, in this embodiment, similarities between characters in the to-be-extracted text and sample characters in the sample set are calculated according to semantic feature vectors, so as to take the label of the sample character with the highest similarity to the character in the to-be-extracted text as the prediction label of the character in the to-be-extracted text, thereby improving the accuracy of the determined prediction label.

The processing unit 303 may generate the semantic feature vector of each character in the to-be-extracted text or the semantic feature vector of each sample character in the sample text directly according to the to-be-extracted text or the sample text.

In order to improve accuracy of the generated semantic feature vector of each character in the to-be-extracted text, when the processing unit 303 generates the semantic feature vector of each character in the to-be-extracted text, the following optional implementation manner may be adopted: acquiring a to-be-extracted field name; splicing the to-be-extracted text with the to-be-extracted field name to obtain token embedding, segment embedding and position embedding of each character in a splicing result; and generating the semantic feature vector of each character in the to-be-extracted text according to the token embedding, the segment embedding and the position embedding of each character.

In order to improve accuracy of the generated semantic feature vector of each sample character in the sample text, in this embodiment, when the processing unit 303 generates the semantic feature vector of each sample character in the sample set, the following optional implementation manner may be adopted: acquiring a to-be-extracted field name; splicing, for each sample text in the sample set, the sample text with the to-be-extracted field name to obtain token embedding, segment embedding and position embedding of each sample character in a splicing result; and generating the semantic feature vector of each sample character in the sample text according to the token embedding, the segment embedding and the position embedding of each sample character. The method for obtaining, by the processing unit 303, the three vectors and the semantic feature vector of each sample character in the sample text is similar to the method for obtaining the three vectors and the semantic feature vector of each character in the to-be-extracted text.

When the processing unit 303 splices the to-be-extracted text with the to-be-extracted field name or splices the sample text with the to-be-extracted field name, splicing may be performed according to a preset splicing rule. Preferably, the splicing rule in the processing unit 303 is “[CLS] to-be-extracted field name [SEP] to-be-extracted text or sample text [SEP]”, wherein [CLS] and [SEP] are special characters.

In this embodiment, after the processing unit 303 determines the prediction label of each character in the to-be-extracted text, the extraction unit 304 extracts, according to the prediction label of each character, a character meeting a preset requirement from the to-be-extracted text as an extraction result of the to-be-extracted text. The preset requirement in the extraction unit 304 may be one of a preset label requirement and a preset label sequence requirement and correspond to the to-be-extracted field name.

When extracting, according to the prediction label of each character, a character meeting a preset requirement from the to-be-extracted text as an extraction result of the to-be-extracted text, the extraction unit 304 may sequentially determine, in a character order, characters in the to-be-extracted text that meet a preset label requirement, and then extract the determined characters to form the extraction result.

In addition, when the extraction unit 304 extracts, according to the prediction label of each character, a character meeting a preset requirement from the to-be-extracted text as an extraction result of the to-be-extracted text, the following optional implementation manner may be adopted: generating a prediction label sequence of the to-be-extracted text according to the prediction label of each character; determining a label sequence in the prediction label sequence meeting a preset label sequence requirement; and extracting, from the to-be-extracted text, a plurality of characters corresponding to the determined label sequence as the extraction result.

That is, in this embodiment, in the manner of generating a prediction label sequence, a field value in the to-be-extracted text corresponding to the to-be-extracted field name can be quickly determined, and then the determined field value is extracted as an extraction result, thereby further improving the efficiency of information extraction.

Acquisition, storage and application of users' personal information involved in the technical solutions of the present disclosure comply with relevant laws and regulations, and do not violate public order and moral.

According to embodiments of the present disclosure, the present disclosure further provides an electronic device, a readable storage medium and a computer program product.

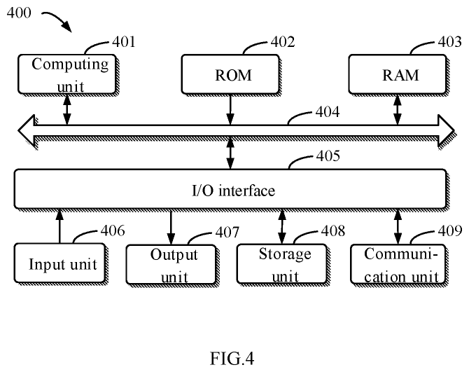

FIG. 4 is a block diagram of an electronic device configured to perform an information extraction method according to embodiments of the present disclosure. The electronic device is intended to represent various forms of digital computers, such as laptops, desktops, workbenches, personal digital assistants, servers, blade servers, mainframe computers and other suitable computing devices. The electronic device may further represent various forms of mobile devices, such as personal digital assistants, cellular phones, smart phones, wearable devices and other similar computing devices. The components, their connections and relationships, and their functions shown herein are examples only, and are not intended to limit the implementation of the present disclosure as described and/or required herein.

As shown in FIG. 4, the device 400 includes a computing unit 401, which may perform various suitable actions and processing according to a computer program stored in a read-only memory (ROM) 402 or a computer program loaded from a storage unit 408 into a random access memory (RAM) 403. The RAM 403 may also store various programs and data required to operate the device 400. The computing unit 401, the ROM 402 and the RAM 403 are connected to one another by a bus 404. An input/output (I/O) interface 405 may also be connected to the bus 404.

A plurality of components in the device 400 are connected to the I/O interface 405, including an input unit 406, such as a keyboard and a mouse; an output unit 407, such as various displays and speakers; a storage unit 408, such as disks and discs; and a communication unit 409, such as a network card, a modem and a wireless communication transceiver. The communication unit 409 allows the device 400 to exchange information/data with other devices over computer networks such as the Internet and/or various telecommunications networks.

The computing unit 401 may be a variety of general-purpose and/or special-purpose processing components with processing and computing capabilities. Some examples of the computing unit 401 include, but are not limited to, a central processing unit (CPU), a graphics processing unit (GPU), various artificial intelligence (AI) computing chips, various computing units that run machine learning model algorithms, a digital signal processor (DSP), and any appropriate processor, controller or microcontroller, etc. The computing unit 401 performs the methods and processing described above, for example, the information extraction method. For example, in some embodiments, the information extraction method may be implemented as a computer software program that is tangibly embodied in a machine-readable medium, such as the storage unit 408.

In some embodiments, part or all of a computer program may be loaded and/or installed on the device 400 via the ROM 402 and/or the communication unit 409. One or more steps of the information extraction method described above may be performed when the computer program is loaded into the RAM 403 and executed by the computing unit 401. Alternatively, in other embodiments, the computing unit 401 may be configured to perform the information extraction method described in the present disclosure by any other appropriate means (for example, by means of firmware).

Various implementations of the systems and technologies disclosed herein can be realized in a digital electronic circuit system, an integrated circuit system, a field programmable gate array (FPGA), an application-specific integrated circuit (ASIC), an application-specific standard product (ASSP), a system on chip (SOC), a load programmable logic device (CPLD), computer hardware, firmware, software, and/or combinations thereof. Such implementations may include implementation in one or more computer programs that are executable and/or interpretable on a programmable system including at least one programmable processor, which can be special or general purpose, configured to receive data and instructions from a storage system, at least one input apparatus, and at least one output apparatus, and to transmit data and instructions to the storage system, the at least one input apparatus, and the at least one output apparatus.

Program codes configured to implement the methods in the present disclosure may be written in any combination of one or more programming languages. Such program codes may be supplied to a processor or controller of a general-purpose computer, a special-purpose computer, or another programmable data processing apparatus to enable the function/operation specified in the flowchart and/or block diagram to be implemented when the program codes are executed by the processor or controller. The program codes may be executed entirely on a machine, partially on a machine, partially on a machine and partially on a remote machine as a stand-alone package, or entirely on a remote machine or a server.

In the context of the present disclosure, machine-readable media may be tangible media which may include or store programs for use by or in conjunction with an instruction execution system, apparatus or device. The machine-readable media may be machine-readable signal media or machine-readable storage media. The machine-readable media may include, but are not limited to, electronic, magnetic, optical, electromagnetic, infrared, or semiconductor systems, apparatuses or devices, or any suitable combinations thereof. More specific examples of machine-readable storage media may include electrical connections based on one or more wires, a portable computer disk, a hard disk, a random access memory (RAM), a read-only memory (ROM), an erasable programmable read only memory (EPROM or flash memory), an optical fiber, a compact disk read only memory (CD-ROM), an optical storage device, a magnetic storage device, or any suitable combination thereof.

To provide interaction with a user, the systems and technologies described here can be implemented on a computer. The computer has: a display apparatus (e.g., a cathode-ray tube (CRT) or a liquid crystal display (LCD) monitor) for displaying information to the user; and a keyboard and a pointing apparatus (e.g., a mouse or trackball) through which the user may provide input for the computer. Other kinds of apparatuses may also be configured to provide interaction with the user. For example, a feedback provided for the user may be any form of sensory feedback (e.g., visual, auditory, or tactile feedback); and input from the user may be received in any form (including sound input, voice input, or tactile input).

The systems and technologies described herein can be implemented in a computing system including background components (e.g., as a data server), or a computing system including middleware components (e.g., an application server), or a computing system including front-end components (e.g., a user computer with a graphical user interface or web browser through which the user can interact with the implementation mode of the systems and technologies described here), or a computing system including any combination of such background components, middleware components or front-end components. The components of the system can be connected to each other through any form or medium of digital data communication (e.g., a communication network). Examples of the communication network include: a local area network (LAN), a wide area network (WAN) and the Internet.

The computer system may include a client and a server. The client and the server are generally far away from each other and generally interact via the communication network. A relationship between the client and the server is generated through computer programs that run on a corresponding computer and have a client-server relationship with each other. The server may be a cloud server, also known as a cloud computing server or cloud host, which is a host product in the cloud computing service system to solve the problems of difficult management and weak business scalability in the traditional physical host and a virtual private server (VPS). The server may also be a distributed system server, or a server combined with blockchain.

It should be understood that the steps can be reordered, added, or deleted using the various forms of processes shown above. For example, the steps described in the present disclosure may be executed in parallel or sequentially or in different sequences, provided that desired results of the technical solutions disclosed in the present disclosure are achieved, which is not limited herein.

The above specific implementations do not limit the extent of protection of the present disclosure. Those skilled in the art should understand that various modifications, combinations, sub-combinations, and replacements can be made according to design requirements and other factors. Any modifications, equivalent substitutions and improvements made within the spirit and principle of the present disclosure all should be included in the extent of protection of the present disclosure.

What is claimed is:

1. An information extraction method, comprising:
acquiring a to-be-extracted text;
acquiring a sample set, the sample set comprising a plurality of sample texts and labels of sample characters in the plurality of sample texts;
determining a prediction label of each character in the to-be-extracted text according to a semantic feature vector of each character in the to-be-extracted text and a semantic feature vector of each sample character in the sample set; and
extracting, according to the prediction label of each character, a character meeting a preset requirement from the to-be-extracted text as an extraction result of the to-be-extracted text.

2. The method according to claim 1, wherein the step of acquiring a sample set comprises: acquiring a pre-constructed sample set.

3. The method according to claim 1, wherein the step of determining a prediction label of each character in the to-be-extracted text according to a semantic feature vector of each character in the to-be-extracted text and a semantic feature vector of each sample character in the sample set comprises:
calculating, for each character in the to-be-extracted text, a similarity between the character and each sample character in the sample set according to the semantic feature vector of the character and the semantic feature vector of each sample character in the sample set; and
taking the label of the sample character with the highest similarity to the character as the prediction label of the character.

4. The method according to claim 1, wherein generating the semantic feature vector of each character in the to-be-extracted text comprises:
acquiring a to-be-extracted field name;
splicing the to-be-extracted text with the to-be-extracted field name to obtain token embedding, segment embedding and position embedding of each character in a splicing result; and
generating the semantic feature vector of each character in the to-be-extracted text according to the token embedding, the segment embedding and the position embedding of each character.

5. The method according to claim 1, wherein generating the semantic feature vector of each sample character in the sample set comprises:
acquiring a to-be-extracted field name;
splicing, for each sample text in the sample set, the sample text with the to-be-extracted field name to obtain token embedding, segment embedding and position embedding of each sample character in a splicing result; and
generating the semantic feature vector of each sample character in the sample text according to the token embedding, the segment embedding and the position embedding of each sample character.

6. The method according to claim 1, wherein the step of extracting, according to the prediction label of each character, a character meeting a preset requirement from the to-be-extracted text as an extraction result of the to-be-extracted text comprises:
generating a prediction label sequence of the to-be-extracted text according to the prediction label of each character;
determining a label sequence in the prediction label sequence meeting a preset label sequence requirement; and
extracting, from the to-be-extracted text, a plurality of characters corresponding to the determined label sequence as the extraction result of the to-be-extracted text.

7. An electronic device, comprising:
at least one processor; and
a memory communicatively connected with the at least one processor;
wherein the memory stores instructions executable by the at least one processor, and the instructions are executed by the at least one processor to enable the at least one processor to perform an information extraction method, wherein the information extraction method comprises:
acquiring a to-be-extracted text;
acquiring a sample set, the sample set comprising a plurality of sample texts and labels of sample characters in the plurality of sample texts;
determining a prediction label of each character in the to-be-extracted text according to a semantic feature vector of each character in the to-be-extracted text and a semantic feature vector of each sample character in the sample set; and
extracting, according to the prediction label of each character, a character meeting a preset requirement from the to-be-extracted text as an extraction result of the to-be-extracted text.

8. The electronic device according to claim 7, wherein the step of acquiring a sample set comprises: acquiring a pre-constructed sample set.

9. The electronic device according to claim 7, wherein the step of determining a prediction label of each character in the to-be-extracted text according to a semantic feature vector of each character in the to-be-extracted text and a semantic feature vector of each sample character in the sample set comprises:
calculating, for each character in the to-be-extracted text, a similarity between the character and each sample character in the sample set according to the semantic feature vector of the character and the semantic feature vector of each sample character in the sample set; and
taking the label of the sample character with the highest similarity to the character as the prediction label of the character.

10. The electronic device according to claim 7, wherein generating the semantic feature vector of each character in the to-be-extracted text comprises:
acquiring a to-be-extracted field name;
splicing the to-be-extracted text with the to-be-extracted field name to obtain token embedding, segment embedding and position embedding of each character in a splicing result; and
generating the semantic feature vector of each character in the to-be-extracted text according to the token embedding, the segment embedding and the position embedding of each character.

11. The electronic device according to claim 7, wherein generating the semantic feature vector of each sample character in the sample set comprises:
acquiring a to-be-extracted field name;
splicing, for each sample text in the sample set, the sample text with the to-be-extracted field name to obtain token embedding, segment embedding and position embedding of each sample character in a splicing result; and
generating the semantic feature vector of each sample character in the sample text according to the token embedding, the segment embedding and the position embedding of each sample character.

12. The electronic device according to claim 7, wherein the step of extracting, according to the prediction label of each character, a character meeting a preset requirement from the to-be-extracted text as an extraction result of the to-be-extracted text comprises:
generating a prediction label sequence of the to-be-extracted text according to the prediction label of each character;
determining a label sequence in the prediction label sequence meeting a preset label sequence requirement; and
extracting, from the to-be-extracted text, a plurality of characters corresponding to the determined label sequence as the extraction result of the to-be-extracted text.

13. A non-transitory computer readable storage medium with computer instructions stored thereon, wherein the computer instructions are used for causing a computer to perform an information extraction method, wherein the information extraction method comprises:
acquiring a to-be-extracted text;
acquiring a sample set, the sample set comprising a plurality of sample texts and labels of sample characters in the plurality of sample texts;
determining a prediction label of each character in the to-be-extracted text according to a semantic feature vector of each character in the to-be-extracted text and a semantic feature vector of each sample character in the sample set; and
extracting, according to the prediction label of each character, a character meeting a preset requirement from the to-be-extracted text as an extraction result of the to-be-extracted text.

14. The non-transitory computer readable storage medium according to claim 13, wherein the step of acquiring a sample set comprises: acquiring a pre-constructed sample set.

15. The non-transitory computer readable storage medium according to claim 13, wherein the step of determining a prediction label of each character in the to-be-extracted text according to a semantic feature vector of each character in the to-be-extracted text and a semantic feature vector of each sample character in the sample set comprises:
calculating, for each character in the to-be-extracted text, a similarity between the character and each sample character in the sample set according to the semantic feature vector of the character and the semantic feature vector of each sample character in the sample set; and
taking the label of the sample character with the highest similarity to the character as the prediction label of the character.

16. The non-transitory computer readable storage medium according to claim 13, wherein generating the semantic feature vector of each character in the to-be-extracted text comprises:
acquiring a to-be-extracted field name;
splicing the to-be-extracted text with the to-be-extracted field name to obtain token embedding, segment embedding and position embedding of each character in a splicing result; and
generating the semantic feature vector of each character in the to-be-extracted text according to the token embedding, the segment embedding and the position embedding of each character.

17. The non-transitory computer readable storage medium according to claim 13, wherein generating the semantic feature vector of each sample character in the sample set comprises:
acquiring a to-be-extracted field name;
splicing, for each sample text in the sample set, the sample text with the to-be-extracted field name to obtain token embedding, segment embedding and position embedding of each sample character in a splicing result; and
generating the semantic feature vector of each sample character in the sample text according to the token embedding, the segment embedding and the position embedding of each sample character.

18. The non-transitory computer readable storage medium according to claim 13, wherein the step of extracting, according to the prediction label of each character, a character meeting a preset requirement from the to-be-extracted text as an extraction result of the to-be-extracted text comprises:
generating a prediction label sequence of the to-be-extracted text according to the prediction label of each character;
determining a label sequence in the prediction label sequence meeting a preset label sequence requirement; and
extracting, from the to-be-extracted text, a plurality of characters corresponding to the determined label sequence as the extraction result of the to-be-extracted text.
